(19) United States
(12) Patent Application Publication
(10) Pub. No.: US 2002/0056054 A1
(43) Pub. Date: May 9, 2002

(54) INFORMATION RECORDING AND/OR REPRODUCING APPARATUS AND METHOD

(76) Inventors: NORIYUKI YAMAMOTO, KANAGAWA (JP); KEIJI KANOTA, KANAGAWA (JP)

Correspondence Address: ATTENTION OF WILLIAM S. FROMMER, ESQ., C/O FROMMER LAWRENCE & HAUG LLP, 745 FIFTH AVENUE, NEW YORK, NY, 10151, US

(21) Appl. No.: 09/261,337

(22) Filed: Mar. 3, 1999

(30) Foreign Application Priority Data
Mar. 4, 1998 (JP) 10-052490

(51) Int. Cl. G06F 12/16

(52) U.S. Cl. 714/8; 711/4; 711/203

(57) ABSTRACT

An information recording and/reproducing apparatus comprises a disc-shaped recording medium having a management information area and a user data area including a plurality of logical blocks, means for writing and/or reading information signal to and/or from at least a part of the user data area on the disc-shaped recording medium, and means for dealing with a defect by detecting a logical block incurring a secondary defect having taken place in the user data area on the disc-shaped recording medium and generating a secondary defect information, thereby permitting to write and/or read timewise continuous data such as a moving picture and sound while maintaining the timewise continuity irrespectively of the existence of the defect on the recording medium.

### BACKGROUND OF THE INVENTION

1. Field of the Invention

The present invention relates to an information recording and/or reproducing apparatus for writing timewise continuous digital data into a recording medium such as a magnetic disc, magneto-optical disc, etc.

2. Description of Related Art

Conventionally, data storage into a digital information recording apparatus is controlled by a file management fiction of an operating system (OS) of a host computer. Namely, any data recording area and blank area on a disc-shaped recording medium (henceforth, disc), an example of the recording medium for use in the digital information recording apparatus, has nothing to do with the recording apparatus, but such data is written along with a command into a area on the disc designated from the host computer.

In MS-DOS and UNIX systems, for example, which are well-known and widely prevailing operating systems, a recording area is segmented, during disc initialization, into data blocks each of a fixed size such as 512 bytes or 1,024 bytes, for example, each being a minimum recording unit to and/or from which data is written and read. The write/read method adopted in the MS-DOS and UNIX systems is called “fixed-size segmentation method”.

The fixed size segmentation is excellent in availability of intra-disc recording area and flexibility of file extension. In the fixed size segmentation, a specific number called “sector ID” is written at the top of each sector during disc initialization. The sector ID is indicative of a physical location on the disc. The sector ID consists of a 8-bit sector number, a 16-bit track number, an 8-bit disc-side number and a 16-bit cyclic redundancy check code (CRC).

The host computer manages this sector ID as a series of logical block addresses (henceforth, LBA) and acquires as LBA an address on the disc to and/or from which data is to be written or read.

Recently, there has been proposed an information recording apparatus using a data format in which no sector ID is provided. In this information recording apparatus, the sector number is managed by hardware for the purpose of data write or read. It adopts the concept of the above-mentioned sector ID, and a block management that data is written or read to and/or from a recording unit of a fixed size.

Next, an information recording and/or reproducing apparatus based on the MS-DOS system, for example, as OS and using a recording medium such as a magnetic disc will be discussed as a typical example of the conventional digital information recording apparatuses.

Referring now to FIG. 1, there is illustrated the conventional information recording and/or reproducing apparatus. It is generally indicated with a reference 100. The apparatus 100 incorporates a hard disc drive (henceforth, HDD) 101 comprising a hard disc D being a magnetic disc, magnetic head (not shown) to write and/or read data to and/or from the hard disc D, voice coil motor (henceforth, VCM) 102 to move the magnetic head to a predetermined track on the hard disc D, servo control circuit 103 to generate a drive signal which drives the VCM 102, buffer 104 to provisionally save data supplied from outside the apparatus 100 and data to be supplied to outside the apparatus 100, R/W channel circuit 105 to generate a signal for write into the hard disc D and reproduce a data read from the hard disc D, microprocessor (henceforth, CPU) 106 to control the above components, and a hard disc controller (henceforth, HDC) 107 to control the recording/reproduction with respect to the buffer 104 based on a control signal from the MPU 106 and supply and receive data to and from the R/W channel circuit 105.

Note that data for write into the hard disc D is a user data to which a parity of error correction code (henceforth, ECC) is added. With an ECC parity thus added, when a sector from which it is tried to read data incurs an ECC error, the information recording and/or reproducing apparatus 100 waits until the hard disc D spins one full turn and retries a reproduction. This operation will be called “retry”. In the ordinary HDD 101, retry is repeated several times, which is an internal operation unnoticeable at the command level. This will be called “hidden retry”. In a hidden retry, since access is made again to a sector from which data is to be read, a latency is required for the hard disc D.

When no reproduction is possible even if retried, a sector from which data read is tried is regarded as defective and alternated with a sector prepared in another or alternative area for a next recording. This will be called “sector alternation method”. A sector alternation will give birth to a seek time required to move the magnetic head to the alternative area, a latency following the seek time, and a seek time and latency required to return the magnetic head to the initial area in order to write or read a subsequent sector. These time requirements are not preferable for continuous transfer of a moving picture data and audio data.

The HDD 101 is connected to a host computer via a bus such as an SCSI (small computer system interface) or IDE (integrated device electronics).

The host computer has installed therein an OS 130 and a logical format program 131, device driver 132 and a basic input/output system (henceforth, BIOS) 133 as other software than the OS 130.

The BIOS 133 is a set of essential software routines on which the hardware related to input/output to and/or from the hard disc D depends.

The device driver 132 is a software component which permits the hard disc D to be accessible as a block device by providing a correspondence between a file and a logical block on the hard disc D.

The logical format program 131 is a program under which an initialization information (including sector ID and file management table) is written into the hard disc D being initialized.

Thus, in an ordinary file management by the host computer, the HDD 101 converts an LBA supplied from the host computer to a sector ID indicative of a physical address on the hard disc D to and/or from which information is written and/or read.

In the information recording and/or reproducing apparatus 100, a defect found, on the hard disc D is deal with during conversion of a LBA supplied to the HDD 101 to an physical address on the hard disc D. Defects possibly taking place on the hard disc D include a primary defect and secondary defect. The primary defect is a one taking place during manufacture or shipment of the hard disc D, namely, a one having taken place before the hard disc D is used by the user. On the other hand, the secondary defect is a one taking place after data write or read to or from the hard disc D have been done several times, namely, a one possibly taking place with the time lapse.

Normally, a hard disc D is fully verified for any primary defect during manufacture or initialization thereof. If a primary defect is detected, a slip alternation process is executed inside the hard disc D during write or read. The slip alternation is such that the magnetic head slips over a defective sector and goes to a normal sector next to the defective one. This slip alternation can be implemented by slipping over a physical address for the defective sector in converting continuous LBAs to physical addresses. It can be implemented in various manners.

On the other hand, when a secondary defect is found on the hard disc D, an “alternate sector process” is employed. This alternate sector process is such that when a sector to which a data is going to be written is found defective, the data is written into an alternative sector having previously been prepared in a separate area. That is, the alternate sector process is used to convert an LBA representing a defective sector to a physical address representing an alternative sector area.

Once a secondary defect is detected during reproduction of a recorded data, the alternate sector method is applied for subsequent write to an alternative sector represented by an LBA for the sector incurring the secondary defect. Therefore in the conventional information recording and/or reproducing apparatus, when the slip alternation process is tried as in dealing with a primary defect, no slip could be done over a physical address for write of data to an alternative sector for a defective sector since data write has been done to a predetermined series of LBAs in the area next to the defective sector.

As shown in FIG. 2, in the information recording and/or reproducing apparatus 100, when recording or reproducing a content designated by the user, the OS 130 is first supplied with a read or write command from a control input device such as an external keyboard or similar operated by the user.

Next, the OS 130 interprets the command according to an internally stored application program and converts it to an LBA.

The OS 130 interprets, by an internally stored file system, the command as an instruction for writing data to n sectors from LBA0, for example, sectors (0, n): 0, 1, 2, 3, . . . , n−1 as shown in FIG. 2. The file system supplies the device driver 132 with an LBA corresponding to the command. The OS 130 allows the device driver 132 to supply the LBA to the HDD 101 via the BIOS 133.

Next, the MPU 106 of the HDD 101 compares the supplied LBA with an internally stored defect list. When an LBA1 is decided to be defective, it is converted for write into an alternative sector m. As a result, the MPU 106 converts the LBAs for write to the sectors 0, m, 2, 3, 4, ..., n−1 in the hard disc D.

Next, the MPU 106 supplies the converted LBAs to the HDC 107 via a MPU bus. The HDC 107 will write or read the data to or from the hard disc D via the R/W channel circuit 105. At this time, each sector in the hard disc D is accessed via a cylinder by driving the magnetic head, for example, following the LBAs. Following the LBAs, the magnetic head writes or reads data to or from an alternative sector area when there exists a logical block incurring a secondary defect.

The conventional information recording and/or reproducing apparatus is destined primarily to write and/or read discrete text data. Therefore, it is disadvantageous as will be described herebelow when writing and/or reading timewise continuous data such as a moving picture, sound, etc.

That is to say, in the information recording and/or reproducing apparatus, when a secondary defect is found in a sector in a hard disc and the alternate sector process is executed within the HDD, many mechanical operations are required for a seek from the defective sector to an alternative sector area and a seek from the alternative sector area to a normal sector next to the defective sector.

The alternate sector process needs a time for seek to the alternative sector area, latency up to the alternative sector, and a time for seek to, and latency up to, the normal sector next to the initial defective sector. Thus, each alternate sector process breaks the timewise continuity of the timewise continuous data. Also, the alternate sector process is repeated each time a defect is found, and thus takes a much idle time for which no data transfer is possible. Therefore, the timewise discontinuity of the alternate sector process will a big problem in write and/or read of timewise continuous data such as a moving picture, sound, etc.

Even if a secondary defect is managed by the host computer outside the HDD, the aforementioned slip alternation process cannot be implemented for the HDD, an ordinary one designed in conformity with the DOS file system, since data are recorded also after the defective. That is, in an ordinary DOS file system, a secondary defect cannot be accommodated unless the alternate sector process is executed against the secondary defect.

If increasingly more secondary defects take place with a longer time lapse in the conventional information recording and/or reproducing apparatus, the alternate sector process has to be executed more frequently and timewise continuous data such as a moving picture, sound, etc. cannot be written or read. Therefore, the service life of such a conventional information recording and/or reproducing apparatus will be determined based only on the reliability of the HDD.

### SUMMARY OF THE INVENTION

Accordingly, the present invention has an object to overcome the above-mentioned drawbacks of the prior art by providing an information recording and/or reproducing apparatus and method, adapted to record timewise continuous data such as a moving picture or sound while keeping the timewise continuity of the data even if a secondary defect exists on a recording medium.

The above object of the present invention can be attained by providing an information recording and/or reproducing apparatus, comprising according to the present invention:

a disc-shaped recording medium having a management information area and a user data area including a plurality of logical blocks;

means for writing and/or reading information signal to and/of from at least a part of the user data area on the disc-shaped recording medium; and

means for dealing with a defect by detecting a logical block incurring a secondary defect having taken place in the user data area on the disc-shaped recording medium and generating a secondary defect information.

In the information recording and/or reproducing apparatus having the above-mentioned configuration, the writing and/or reading means writes and/or reads information signal to and/or from a next logical block timewise contiguous to a logical block decided to be defective based on the secondary defect information generated by the defect dealing means.

The above object can also be attained by providing an information recording and/or reproducing method, comprising, according to the present invention, the steps of:

detecting a logical block incurring a secondary defect having taken place in a user data area on a disc-shaped recording medium having a management information area and a user data area including a plurality of logical blocks; and

writing and/or reading information signal to and/or from a next logical block timewise contiguous to the defective logical block.

In the above information recording and/or reproducing method, information signal is written and/or read to and/or from the next logical block timewise contiguous to the logical block incurring the secondary defect.

The above object can also be attained by providing an information recording and/or reproducing apparatus, comprising according to the present invention:

means for writing and/or reading information signal to and/or from a user data area, including a plurality of logical blocks, on a disc-shaped recording medium having also a management information area, irrespectively of the existence of a secondary defect in the user data area, while detecting a secondary defect having taken place in the disc-shaped recording medium;

means for storing, as a logical block number, a secondary block detected by the writing and/or reading means in any of the logical blocks of the user data area; and

means for supplying as an output the secondary defect stored in the defect storing means, after write and/or read of the information signal to and/or from the writing and/or reading means.

In the information recording and/or reproducing apparatus having the above-mentioned configuration, the writing and/or reading means detects a secondary defect, stores the logical block number of the logical block incurring the detected secondary defect, and supplies it as an output.

The above object can also be attained by providing an information recording and/or reproducing method, comprising, according to the present invention, the steps of:

writing and/or reading information signal to and/or from a user data area, including a plurality of logical blocks, on a disc-shaped recording medium having also a management information area, irrespectively of the existence of a secondary defect in the user data area;

detecting a secondary defect having taken place in the disc-shaped recording medium;

storing as a logical block number a secondary block in any of the logical blocks; and

supplying as an output the stored secondary defect after write and/or read of the information signal.

In the above-mentioned information recording and/or reproducing method, information signal is written and/or read irrespectively of the existence of a secondary defect, a secondary defect having taken place in the disc-shaped recording medium is detected and stored as a logical block number, and the stored secondary defect is supplied as an output after write and/or read of the information signal.

These objects and other objects, features and advantages of the present intention will become more apparent from the following detailed description of the preferred embodiments of the present invention when taken in conjunction with the accompanying drawings.

### BRIEF DESCRIPTION OF THE DRAWINGS

FIG. 1 is a schematic block diagram of a conventional information recording and/or reproducing apparatus;

FIG. 2 explains an example of the address conversion effected in the conventional information recording and/or reproducing apparatus to generate an LBA (logical block address) to and/or from which write or read is done under a control input signal;

FIG. 3 a schematic block diagram of an embodiment of the information recording and/or reproducing apparatus according to the present invention;

FIG. 4 shows the configuration of a file system stored into ROM;

FIG. 5 shows the configuration of a root area of the file system;

FIG. 6 shows the configuration of a TOC area of the file system;

FIG. 7 shows the configuration of a defect-list area of the file system;

FIG. 8 shows the configuration of an example of AV cluster stored into a user area;

FIG. 9 shows the configuration of the AV cluster, showing the capacity of the AV cluster when in each of the writing modes, of which

FIG. 9(A) shows the AV cluster when in the Edit mode;

FIG. 9(B) shows the AV cluster when in the HP mode;

FIG. 9(C) shows the AV cluster when in the SP mode; and

FIG. 9(D) shows the AV cluster when in the LP mode;

FIG. 10 shows the configuration of the AV cluster when moving picture data is compressed by the Wavelet method and audio data is compressed by the MPEG-Audio or ATRAC method; of which

FIG. 10(A) shows the AV cluster when moving picture data is compressed by the Wavelet method and audio data corresponding to the moving picture data is compressed by the MPEG-Audio or ATRAC method;

FIG. 10(B) shows the AV cluster when in the SP mode; and

FIG. 10(C) shows the AV cluster when in the LP mode;

FIG. 11 shows the configuration of an audio cluster stored into the user data area;

FIG. 12 shows the configuration of a still picture stored into the audio data area;

FIG. 13 shows an example of address conversion effected in the information recording and/or reproducing apparatus of the present invention to generate an LBA (logical block address) to and/or from which write or read is done under a control input signal;

FIG. 14 explains an example of read from LBA0 when write point (WP) lies at LBA0 and “1” is stated in a first defect list(A);

FIG. 15(A) explains an example of reference to only the first defect list for read from a point WP=4 and subsequent addresses to the first and second defect lists for reading LBA0 to LBA3;

FIG. 15(B) explains an example of writing AV data at LBA0 after returning to LBA0 again from the point WP=4;

FIG. 16 is a flow chart of operations for AV data write into AV data area, by way of example, in the information recording and/or reproducing apparatus of the present invention;

FIG. 17 is a flow chart of operations for dealing with a secondary defect in the AV data area; and

FIG. 18 is a flow chart of operations for AV data read from the AV data area, by way of example, in the information recording and/or reproducing apparatus.

### DETAILED DESCRIPTION OF THE PREFERRED EMBODIMENTS

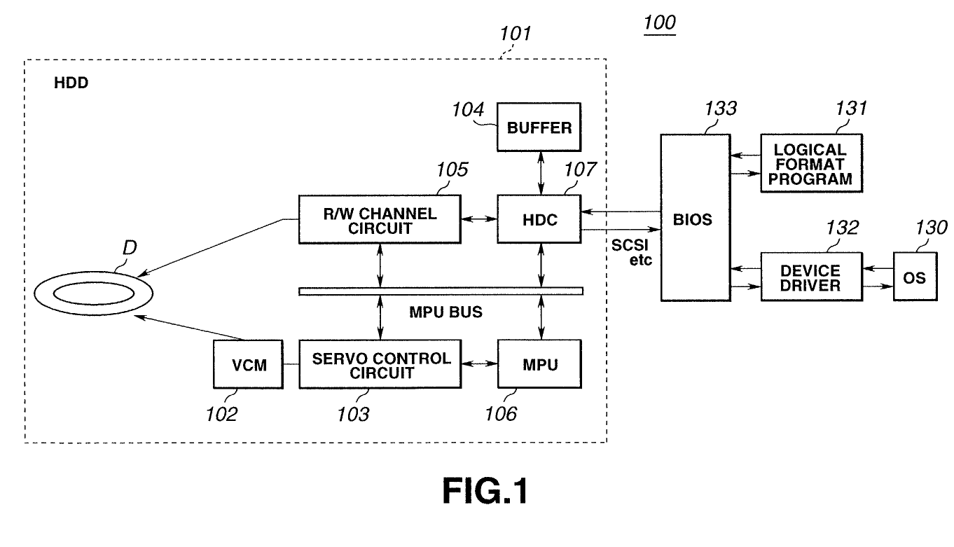

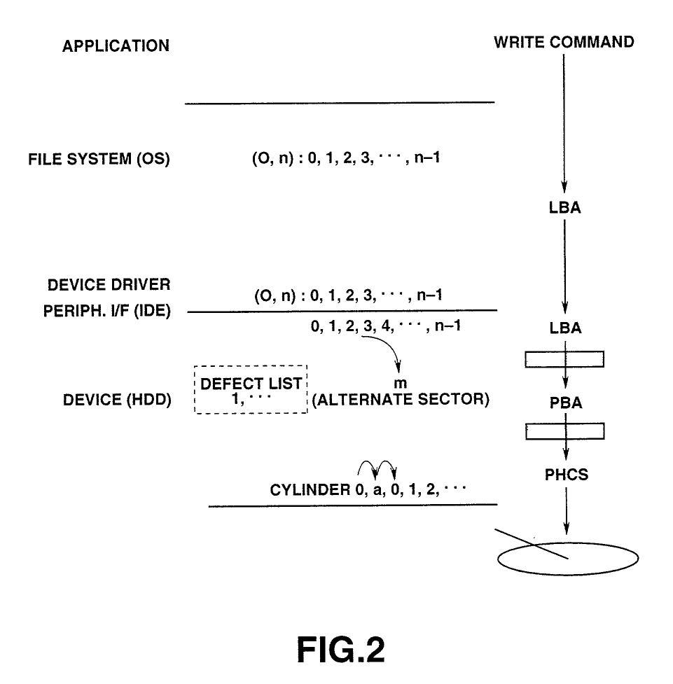

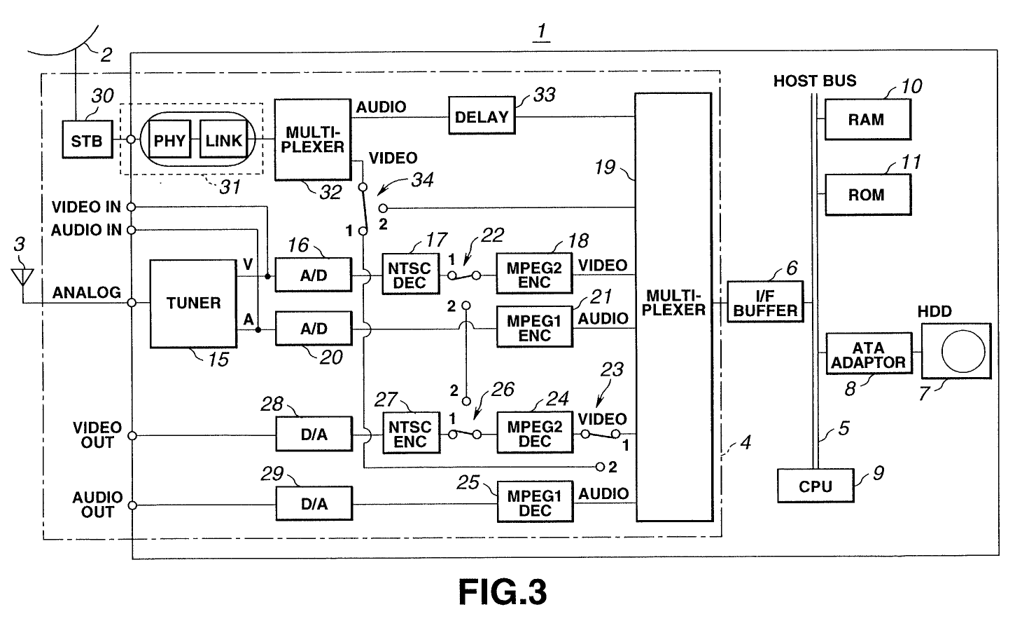

Referring now to FIG. 3, there is illustrated an embodiment of the information recording and/or reproducing apparatus according to the present invention. The information recording and/or reproducing apparatus is generally indicated with a reference 1. As shown in FIG. 1, the information recording and/or reproducing apparatus 1 comprises an antenna 2 to receive digital data compressed according to MPEG (Moving Picture coding Experts Group), an antenna 3 to receive analog signal conforming to NTSC (National Television System Committee), a signal processor circuit 4 to process a digital data and analog data received and supplied from the antennas 2 and 3, respectively, a host bus 5 being a common bus to transmit information, an interface buffer 6 to transfer information between the signal processor circuit 4 and host bus 5, an HDD (hard disc drive) 7 having a recording medium in which information is to be recorded, and a so-called ATA (At Attachment) adaptor 8 to transfer information between the host buts 5 and HDD7.

The host bus 5 is a parallel-line transmission line over which information is sent between components of the information recording and/or reproducing apparatus 1.

The interface buffer 6 transfers an audio and/or visual digital data stream (henceforth, AV data) between the signal processor circuit 4 and host bust 5. For instance, the interface buffer 6 changes the transfer rate of AV data or adjust the transfer timing. It incorporates a two-bank RAM which is composed of two RAMs which are selected alternatively to adjust the transfer of information.

The HDD 7 is a fixed disc drive to record a supplied AV data. The ATA adapter 5 is disposed between the host bus 5 and HDD 7 to convert an AV data between a parallel data on the host bus 5 and a data formatted in the HDD 7.

The HDD 7 incorporates a recording medium which writes AV data multiplexed by the multiplexer 19 according to a file system which will be described later. The HDD 7 incorporates also a magnetic head when it has a recording medium such as a magnetic disc installed therein and will write a timewise continuous AV data into the magnetic disc.

When writing continuous AV data into the magnetic disc, the magnetic head is controlled to follow a track formed on the magnetic disc by scanning it from the outer circumferential area to inner circumferential area on the magnetic disc . In the HDD 7, after data is written on the magnetic disc from the outermost area to innermost area, the magnetic head is returned to the outermost area for writing the AV data again.

The information recording and/or reproducing apparatus 1 further incorporates a central processing unit (henceforth, CPU) 9 to provide a control over the information write and read, RAM 10 a volatile memory, and an ROM 11 a nonvolatile memory.

The CPU 9 is connected to the host bus 5 to control the data transfer and HDD 7, namely, it has a control, by software, over a sequence of operations in information writing by the information recording and/or reproducing apparatus 1. The software starting up the sequence of operations is recorded in the ROM 11, for example, and read from the ROM 11 for execution as necessary. The CPU 9 adopts the RISC (Reduced Instruction Set Computer) system in which the basic instructions are reduced in number by simplification for an improved operating speed.

Also, the CPU 9 is connected to a control input device (not shown) such as a keyboard or similar, and supplied with a control input signal, for example, from the user. Supplied with a control input signal to write and read an AV data, for example, the CPU 9 controls each component of the information recording and/or reproducing apparatus 1 according to the control input signal.

The ROM 11 stores a file system being a control program which will be described later. The file system stored in the ROM 11 will be read by the CPU 9 which will control the write to, and read from, the HDD 7 under the read file system.

The RAM 10 is a volatile memory connected to the host bus 5 to temporarily store data. The ROM 11 is a nonvolatile memory connected to the host bus 5 to store a predetermined data and software.

The RAM 10 stores a root stored in the HDD 7 at the time of start-up and data write or read and which will be discussed later, and a management information indicative of TOC. The management information will be updated at any time by the CPU 9 at the time of start-up and data write or read.

The RAM 10 is connected to the host bus 5 and controlled by the CPU 9. The RAM 10 stores a defect list including secondary defects having taken place in the user data area on the recording medium and which will be described later. The RAM 10 stores the management information in he HDD 7 at the time of start-up and data write or read. The information stored in the RAM 10 will be updated at any time by the CPU 9.

The signal processor circuit 4 comprises a tuner 15 to receive a signal via the antenna 3 which receives analog video and audio signals, A/D converter circuit 16 which converts to a digital signal an analog video signal supplied from the tuner 15, NTSC decoder 17 which is supplied with a digital video signal from the A/D converter circuit 16, MPEG-2 encoder 18 which is supplied with a video signal having been coded to a base band signal by the NTSC decoder 17, and a multiplexer 19 which is supplied with a digital MPEG AV data from the MPEG-2 encoder 18.

The signal processor circuit 4 further comprises another A/D converter circuit 20 which is supplied with an audio data from the tuner 15, and an MPEG-1 encoder 21 which is supplied with a digital audio signal from the A/D converter circuit 20.

The tuner 15 is supplied with an NTSC signal, for example, received by the antenna 3. The tuner 15 receives and demodulates video and audio signals fed from the antenna 3. Then it supplies the demodulated video signal to the A/D converter circuit 16 while supplying the modulated audio signal to the A/D converter circuit 20.

The A/D converter circuit 16 converts a video signal supplied from a video input terminal or the tuner 15 from analog to digital to provide a video data. Then it supplies an NTSC video data, for example, to the NTSC decoder 17.

The NTSC decoder 17 will decompress the supplied NTSC video data from the A/D converter 16 to produce a base band signal which will be supplied to the MPEG-2 encoder 18 via a terminal-1 of a switch 22.

The MPEG-2 encoder 18 will compress the base band signal supplied from the NTSC decoder 17 to provide an MPEG-2 digital data. In the MPEG-2 encoder 18, the supplied base band signal is compressed at a rate designated by the CPU 9 for the maximum size of an output GOP (Group of Picture) and/or I frame from the MPEG-2 encoder 18 to be an integral number of times of the size of a logical sector in the recording medium.

The MPEG-2 encoder 18 is further supplied with a base band signal from an MPEG-2 decoder 24 via a terminal-2 of the switch 22 and a terminal-2 of a switch 26. Also the MPEG-2 encoder 18 compresses the base-band signal from the MPEG-2 decoder 24 at a predetermined rate.

On the other hand, the tuner 15 supplies the A/D converter circuit 20 with the audio of the signals fed from the antenna 3. The A/D converter circuit 20 will convert the supplied audio signal from analog to digital to provide an audio data which will be supplied to the MPEG-1 encoder 21.

The MPEG-1 encoder 21 compresses the audio data supplied from the A/D converter circuit 20 by the MPEG-1 method, and supplies the compressed data to the multiplexer 19.

The multiplexer 19 multiplexes the video data supplied from the MPEG-2 encoder 18 and audio data supplied from the MPEG-1 encoder 21. Under the assumption that the video data is V and audio data is A, the multiplexer 21 will compress the video and audio data to be VAVAVA . . . along the time base in the time unit of GOP of the MPEG signal, for example, to thereby produce an AV data. The multiplexer 19 supplies the resultant AV data to the interface buffer 6.

Further, the multiplexer 19 is supplied with an AV data recorded in the recording medium in the HDD 7 from the interface buffer 6, and divides the supplied AV data into a video data and audio data. It supplies the video data to a multiplexer 32 via a terminal-2 of a switch 34 and to the MPEG-2 decoder 24 via a terminal-1 of a switch 23. Also, it supplies the audio data to a multiplexer 32 via a delay circuit 33 and to an MPEG-1 decoder 25.

The signal processor circuit 4 comprises the antenna 2 which receives an MPEG digital data, set top box (henceforth, STB) 30, digital I/F circuit 31, multiplexer 32 and a delay circuit 33.

The antenna 2 receives an MPEG digital data, for example, as in the foregoing, and supplies it as an RF signal to the STB 30.

The STB 30 works as a front end to receive and demodulate a digital data from the antenna 2. It decrypts an encrypted or scrambled digital data, for example, to supplies it to the digital I/F circuit 31.

Also, the STB 30 is supplied with a digital data from the digital I/F circuit 31. The STB 30 incorporates an MPEG decoder. Using this MPEG decoder, the STB 30 decodes the digital data from the digital I/F circuit 31 by decompressing a compressed video data and audio data, for example, to produce a video signal and audio signal.

The digital I/F circuit 31 has a physical layer/link layer processing circuit to convert a digital data from the STB 30, and supplies it to the multiplexer 32.

Further, the digital I/F circuit 31 is supplied with a digital data from the multiplexer 32. This digital data is a one produced by multiplexing a video data and audio data. The digital I/F circuit 31 supplies the digital data to the STB 30.

The multiplexer 32 divides the digital data received from the digital I/F circuit 31 into a video data and audio data, and supplies the video data to the MPEG-2 decoder 24 via a terminal-1 of the switch 34 and terminal-2 of the switch 23 while supplying the audio data to the delay circuit 33.

The multiplexer 32 is supplied with the video data from the multiplexer 19 via the switch 34 and also with the audio data via the delay circuit 33. It multiplexes the supplied video and audio data, and supplies the multiplexed data to the digital I/F circuit 31.

The delay circuit 33 delays the audio data supplied from the multiplexer 32 for adjustment of the time difference between the supplied audio and video data, and supplies the delayed audio data to the multiplexer 19.

Further, the delay circuit 33 is supplied with only the audio of the video and audio data obtained through the division by the multiplexer 19, and adjusts the delay of the audio data from the video data. It supplies the audio data to the multiplexer 32.

The signal processor circuit 4 comprises an MPEG-2 decoder 24 which is supplied with a video data via the terminal-2 of the switch 23, MPEG-1 decoder 25 which is supplied with an audio data obtained through the division of the digital data by the multiplexer 19, NTSC encoder 27 which is supplied, via a terminal-1 of a switch 26, with a video data decoded by the MPEG-2 decoder 24, D/A converter circuit 28 which is supplied with a data coded by the NTSC encoder 27, and a D/A converter circuit 29 which is supplied with an audio data coded by the MPEG-1 decoder 25.

The MPEG-2 decoder 24 is supplied, via the terminal-1 of the switch 23, with a video data obtained through the division by the multiplexer 19 of an AV data read from the HDD 7 under a data transfer software in the CPU 9 and which is passed through the ATA adapter 8, host bus 5 and interface buffer 6 to the multiplexer 19. The MPEG-2 decoder 24 decompresses the supplied video data having been compressed. The MPEG-2 decoder 24 is supplied also with a video data from the multiplexer 32 via the terminal-2 of the switch 23. It passes the video data thus decompressed to the switch 26.

The switch 23 is controlled for connection to the terminal-2 to supply the video data from the multiplexer 32 to the MPEG-2 decoder 24, and to the terminal-1 to supply the video data from the multiplexer 19 to the MPEG-2 decoder 24.

The switch 26 is controlled for connection to the terminal-2 to supply the video data from the MPEG-2 decoder 24 to the switch 22, and to the terminal-1 to supply the video data from the MPEG-2 decoder 24 to the NTSC encoder 27.

The NTSC encoder 27 is supplied, via the terminal-1 of the switch 26, with the video data decoded by the MPEG-2 decoder 24. It compresses the supplied video data by the NTSC system, and supplies the compressed video data to the D/A converter circuit 28.

The D/A converter circuit 28 converts the video data from the NTSC encoder 27 from digital to analog to produce a video signal, and delivers the video signal at a video output terminal thereof.

The MPEG-1 decoder 25 is supplied with the audio data obtained through the division of the digital data by the multiplexer 19, and decompresses the supplied audio data. Then it supplies the decompressed audio data to the D/A converter circuit 29.

The D/A converter circuit 29 converts the audio data from the MPEG-1 decoder 25 from digital to analog to produce an audio signal, and delivers the audio signal at an audio output terminal thereof.

In this signal processor circuit 4, for write of an MPEG digital data received by the antenna 2 into the recording medium in the HDD 7, the digital data is first supplied to the multiplexer 32 via the STB 30 and digital I/F circuit 31.

The multiplexer 32 divides the supplied digital data into a video data and audio data, and supplies the audio data to the delay circuit 33.

Also, the multiplexer 32 supplies the video data to the MPEG-2 decoder 24 via the switches 34 and 23. At this time, the switch 34 is controlled for connection to the terminal-1 while the switch 23 is controlled for connection to the terminal-2.

The MPEG-2 decoder 24 decompresses the compressed video data, and supplies the decompressed video data to the MPEG-2 encoder 18 via the switches 26 and 22. At this time, the switch 26 is controlled for connection to the terminal-2 while the switch 22 is controlled for connection to the terminal-2.

The MPEG-2 encoder 18 compresses the supplied video data having been compressed at the predetermined rate. At this time, the MPEG-2 encoder 18 compresses GOP and/or I picture at a rate designated by the CPU 9 for their data size to be an integral number of times of the size of a logical sector in the recording medium in the HDD 7.

The audio data delayed by the delay circuit 33 is supplied to the multiplexer 19 at a controlled timing, and the video data from the MPEG-2 encoder 18 is supplied to the multiplexer 19.

The multiplexer 19 multiplexes the supplied audio and video data to produce an AV data, and stores the AV data into the recording medium in the HDD 7 via the interface buffer 6, host bust 5 and ATA adapter 8. Therefore, the information recording and/or reproducing apparatus 1 will record an MPEG data in each of logical sectors in the recording medium.

Also in the information recording and/or reproducing apparatus 1, for write of an NTSC analog signal received by the antenna 3 into the recording medium in the HDD 7, the analog signal is first supplied to the tuner 15.

The tuner 15 will demodulate the analog signal from the antenna 3, and supply a video signal to the A/D converter circuit 16 and an audio signal to the A/D converter circuit 20. At this time, the A/D converter circuit 16 may be supplied at the video input terminal thereof with a video signal, and the A/D converter circuit 20 be supplied at an audio input terminal thereof with an audio signal.

The A/D converter circuit 16 will convert the supplied video signal from analog to digital to produce a video data, and supply the video data to the NTSC decoder 17.

Next, the NTSC decoder 17 decompresses the video data from the A/D converter circuit 16, and supplies the decompressed video data as a base band signal to the MPEG-2 encoder 18. At this time, the switch 22 is controlled for connection to the terminal-1.

The MPEG-2 encoder 18 is thus supplied with the base band signal via the switch 22, and compresses the supplied base band signal at a predetermined rate designated by the CPU 9 to produce an MPEG-2 video data. Then, it compresses GOP and/or I frame of the MPEG-2 video data for their data size to be an integral number of times of the size of a logical sector in the recording medium in the HDD 7. Then, it supplies the compressed the data to the multiplexer 19.

On the other hand, the A/D converter circuit 20 converts the audio signal from the tuner 15 from analog to digital to produce an audio data which will be supplied to the MPEG-1 encoder 21.

The MPEG-1 encoder 21 codes the audio data from the A/D converter circuit 20 according to the MPEG-1 system, and supplies the coded audio data to the multiplexer 19.

The multiplexer 19 will multiplex the video data supplied from the MPEG-2 encoder 18 and audio data from the MPEG-1 encoder 21 to produce an AV data.

The multiplexer 19 will then record the produced AV data into the recording medium in the HDD 7 via the interface buffer 6, host bus 5 and ATA adapter 8. Therefore, the information recording and/or reproducing apparatus 1 will thus record the MPEG AV data in each of the logical sectors in the recording medium.

In the information recording and/or reproducing apparatus 1, for reading an AV data from the recording medium in the HDD 7, first the data transfer software which is started up by the CPU 9 will scan each of the logical sectors in the recording medium in the HDD 7. At this time, the CPU 9 may read the AV data stored in the HDD 7 in various variable-speed modes of reading, for example, under the software control.

In the information recording and/or reproducing apparatus 1, the AV data read from the HDD 7 is supplied via the ATA adapter 8, host bus 5 and interface buffer 6 to the multiplexer 19 where the supplied AV data will be divided into a video data and audio data.

In the signal processor circuit 4, for read of an AV data recorded in the recording medium as a digital data, a video data is supplied from the multiplexer 19 to the multiplexer 32 via the switch 34, and an audio data has a delay from the video data adjusted by the delay circuit 33 and is supplied to the multiplexer 32.

The multiplexer 32 will multiplex the supplied audio and video data, and supply the multiplexed data to the digital I/F circuit 31. The audio and video data are supplied to the STB 30 where they will be processed by the MPEG decoder incorporated therein into an audio signal and video signal. These signals are subject to any of a variable-speed reproduction, seamless reproduction and nonlinear edit reproduction, for example, under the software control by the CPU 9.

On the other hand, in the signal processor circuit 4, for reproduction as an analog signal of an AV signal recorded in the recording medium, the video data from the multiplexer 19 is supplied to the MPEG-2 decoder 24 via the terminal-1 of the switch 23.

The MPEG-2 decoder 24 will decode the video data from the multiplexer 19, and supply the decoded video data to the NTSC encoder 27 via the terminal-1 of the switch 26.

The NTSC encoder 27 will convert the digital data from the MPEG-2 decoder 24 to an NTSC video data, and supply the NTSC video data to the D/A converter circuit 28.

The D/A converter circuit 28 will convert the video data from the NTSC encoder 27 from digital to analog to produce an NTSC video signal, and deliver the NTSC video signal at the video /output terminal thereof.

The multiplexer 19 supplies the audio data to the MPEG-1 decoder 25 which will decode the audio data from the multiplexer 19 and supply the decoded audio data to the D/A converter circuit 29.

The D/A converter circuit 29 will convert the audio signal from the MPEG-1 decoder 25 from digital to analog, and deliver the analog signal at the audio output terminal thereof.

As mentioned in the foregoing, for recording an MPEG digital data compressed according to the MPEG system into the information recording and/or reproducing apparatus 1, it is decoded by the MPEG-2 decoder 24 and compressed by the MPEG-2 encoder 18 at a predetermined rate for its data size to be an integral number of times of the size of a logical sector in the hard disc. When an NTSC signal is supplied for recording in the apparatus 1, it is coded by the MPEG-2 encoder 18. Namely, the recorded digital data can be reproduced just by designating an address information in the hard disc under the data transfer software, for example. It is possible to easily get access to the hard disc. Therefore, the information recording and/or reproducing apparatus 1 can reproduce data at a variable speed, for example and adopt a variety of reproducing methods.

The information recording and/or reproducing apparatus 1 according to the present invention has been described concerning an example that the MPEG-2 encoder 18 is used to compress data for the data size to be an integral number of tunes of the size of a logical sector in the hard disc. However, the MPEG-2 encoder 18 may be adapted to compress data at a plurality of fixed rates.

More particularly, for using a compressed AV data recorded in the hard disc, the MPEG-2 encoder 18 may compress the data at a rate of 8 Mbps; for a standard play (SP), the MPEG-2 encoder 18 may compress the data at a rate of 4 Mbps, and for a long play (LP), the MPEG-2 encoder 18 may compress the data at a rate of 2 Mbps. For reproduction of an AV data recorded in the hard disc in the information recording and/or reproducing apparatus 1, the data transfer software is controlled by the CPU 9 to vary the capacity of storage, for example, thereby permitting to reproduce data as in the above.

Also, the information recording and/or reproducing apparatus 1 has been described in the foregoing concerning the CPU 9 and HDD 7 using the ATA interface. However, the interface may of course be an SCSI interface or the like.

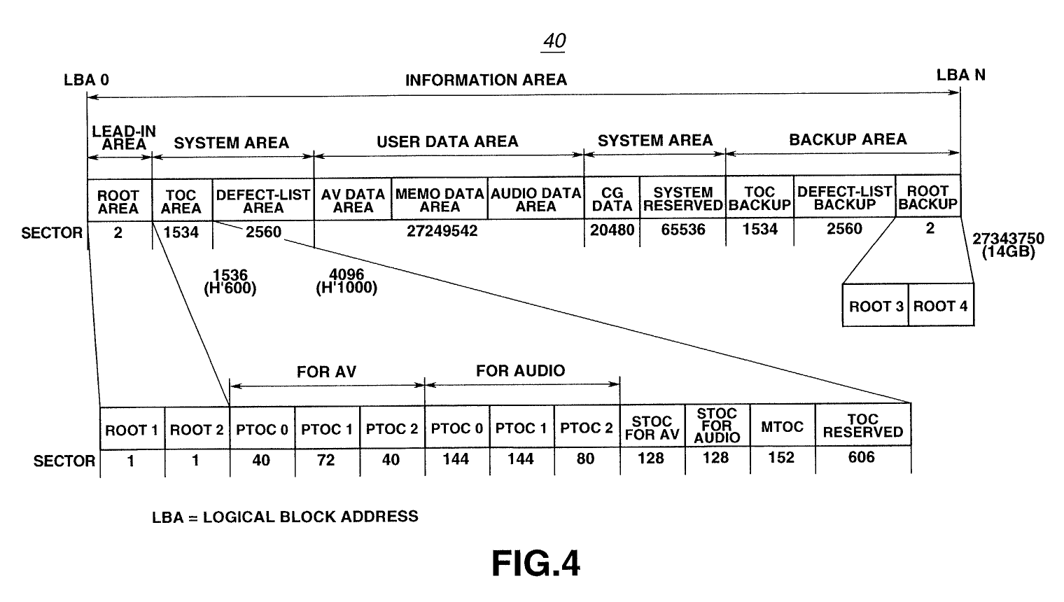

Next, the file system stored in the ROM 11 will be discussed herebelow. FIG. 4 illustrates an example of configuration of the file system. The file system is generally indicated with a reference 40. As shown, the file system 40 has an information area of about 14 GB in capacity including logical block addresses (henceforth, LBA) from 0 to N.

The information area of the file system 40 includes a lead-in area, first system area, user data area, second system area and backup area.

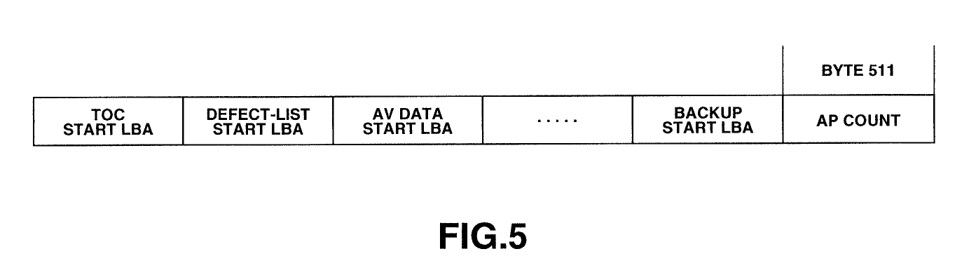

The lead-in area comprises a root area for 2 sectors. As shown in FIG. 5, the root area stores information indicative of a table of contents (henceforth, TOC) start LBA, defect list area start LBA, user data area start LBA, backup area start LBA, etc. The root area stores also information indicative of a start LBA of an AV data area in the user data area (henceforth, write start LBA); memo data area start LBA, audio data area start LBA, etc. Owing to this configuration, the root area stores segmentation position information indicating the entire configuration of the file system 40.

The root area includes a root 1 and root 2 both of which have a same content against a trouble.

The root area stores APCount in the last portion thereof. The APCount is a data which is incremented each time the root area is rewritten. The APCount is disposed in positions at which the lead-in and lead-out areas are partitioned.

As shown in FIG. 4, the first system area consists of a TOC area having 1,534 sectors, and a defect list area having 2,560 sectors. The TOC area stores management information on an AV data which is recorded in the user data area. The defect list area stores a table under which secondary defects having taken place in the user data area are managed.

The TOC area may have a generally same configuration as in an MD (minidisc), for example, and consists of areas PTOC 0 to 2 used for moving picture data, areas PTOC 0 to 2 for audio data, STOC area for moving picture data, STOC area for audio data, MTOC, and a TOC reserved area.

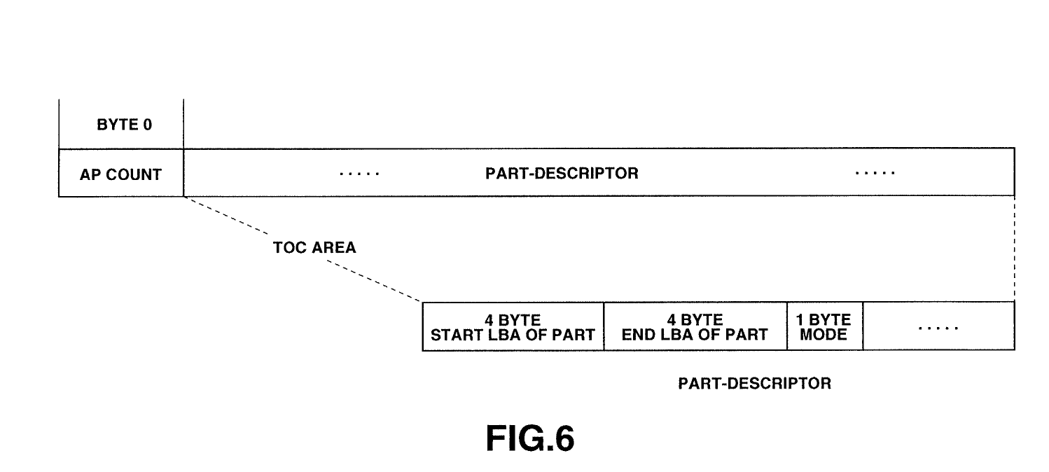

As shown in FIG. 6, the TOC area stores APCount in the top LBA. Following the APCount, there are stored in the TOC area a segmentation position information for each information stored in the user data area, and a recording mode information including a compression system, compression rate for the compression system, etc.

The TOC area stores also a segmentation position information of 4 bytes indicating a start LBA and end LBA and a recording mode information of 1 byte, for each information stored in the user data area.

Further, the TOC area has a STOC for seamless reproduction, for example, which stores LBA for an AV data area which is seamlessly reproduced. The STOC stores a read start LBA of 4 bytes indicating the content of a data to be seamlessly reproduced, and a read end LBA. The CPU 9 will seamlessly reproduce an AV data by reproducing the AV data according to the an LBA stored in the STOC.

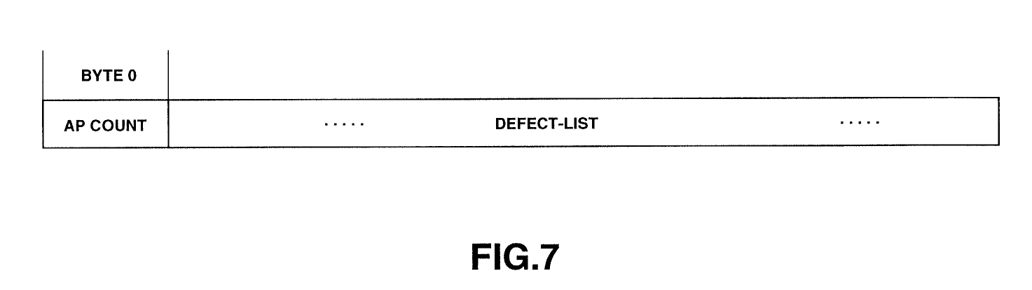

As shown in FIG. 7, the defect list area stores APCount in the top LBA and a secondary defect management table after the APCount.

Further, the defect list area stores a list of secondary defects having taken place in the AV data area. The secondary defect lists include a first defect list used when recording an AV data area one round before a current AV data, second defect list generated when reproducing the AV data area one round before, and a third defect list generated when reproducing an AV data recorded using the first and second defect lists. These defect lists store LBAs which are not recordable or reproducible due to secondary defects having taken place therein.

The defect lists are written and stored into the RAM 10 by the CPU 9 at the start-up of the information recording and/or reproducing apparatus 1, for example. They will additionally store an defective LBA at which a secondary defect has been detected during recording or reproduction. The recording unit of the defect list depends upon the capacity of the AV data area. For example, when the AV data area has a capacity of 8 gigabytes, the recording unit may be of 3 bytes. When no secondary defect exists or no additional secondary defect exists in the recording medium, the defect list is set as h′FFFFFF, for example.

As shown in FIG. 4, the user data area consists of 27,249,542 sectors, comprising an AV data area, memo data area and an audio data area. The area sizes of the user data area correspond to the segmentation position information stored in the above-mentioned root area.

The user data area in a disc-shaped recording medium, for example, has disposed therein an AV data area, memo data area, and audio data area in this order from the outer circumference of the recording medium. The AV data area, memo data area and audio data area have addresses indicative of their respective top LBAs recorded in the root area.

The AV data area records compressed AV data including a moving picture data compressed by the MPEG-2 compression method, and data compressed by the Wavelet compression method. The AV data area records also a compression rate selectively used in the MPEG-2 compression method in such a mode that the compression rate is 8 Mbps, 6 Mbps, 4 Mbps or 2 Mbps. On the other hand, in the Wavelet compression method, the AV data is recorded in the AV data area in such a mode that the rate is 8 Mbps or 6 Mbps.

The AV data area records mainly a moving picture data and audio data accompanying the moving picture data in a timewise succession from the write start LBA. When AV data have been written sequentially in this AV data area sequentially to the write start LBA and subsequent LBAs, AV data will be overwritten in the AV data area to the write start LBA and subsequent LBAs again. This is the so-called ring-storage structure. AV data recorded in the AV data area will be reproduced timewise continuously.

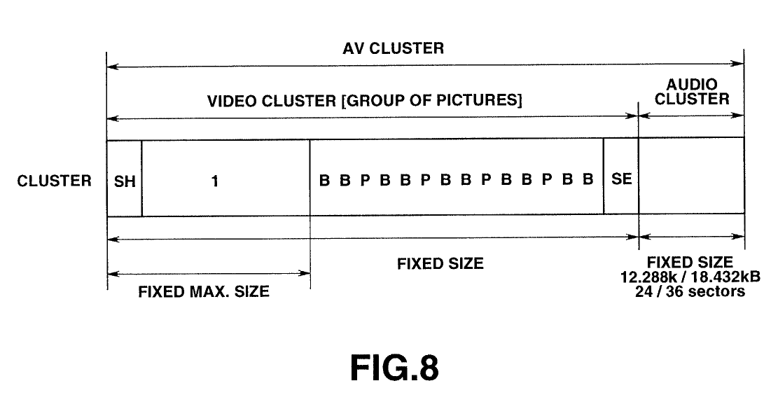

In the AV data area, moving picture data and audio data are recorded in each of AV clusters, as a minimum unit of recording, as shown in FIG. 8. The AV cluster includes a video cluster composed of a sequence header code (SH), group of pictures (henceforth, GOP) and a sequence end code (SE), and an audio cluster.

The video and audio clusters in the AV data area are compressed to the size of a sector at such a rate selected by the CPU 9 for recording into the recording medium in the HDD 7. The AV data area is composed of 2″ sectors owing to the selected compression rate.

The GOP consists of I pictures coded by intra-frame prediction, P pictures coded by inter-frame forward prediction, and B pictures coded by bidirectional prediction. In this embodiment, parameters M and N for the GOP are M=3 and N=15, respectively. Namely, in this embodiment, one GOP consists of 15 pictures in which the I or P picture is disposed at every third position. It is assumed here that the I picture has a fixed maximum size and GOP has also a fixed size.

The audio cluster stores an audio data corresponding to GOP, compressed by the MPEG-Audio or ATRAC (Adaptive Transformer Acoustic Coding) method. The audio cluster is of a fixed size corresponding to one GOP. In this embodiment, an audio data for storage into the audio cluster is compressed by the MPEG-Audio method to have 12.288 kilobytes for 24 sectors or by the ATRAC method to have 18.432 kilobytes for 36 sectors. Since the entire AV cluster is of a fixed size, a video data for storage into the video cluster is compressed at a rate varied correspondingly to a variation of the capacity of the audio cluster.

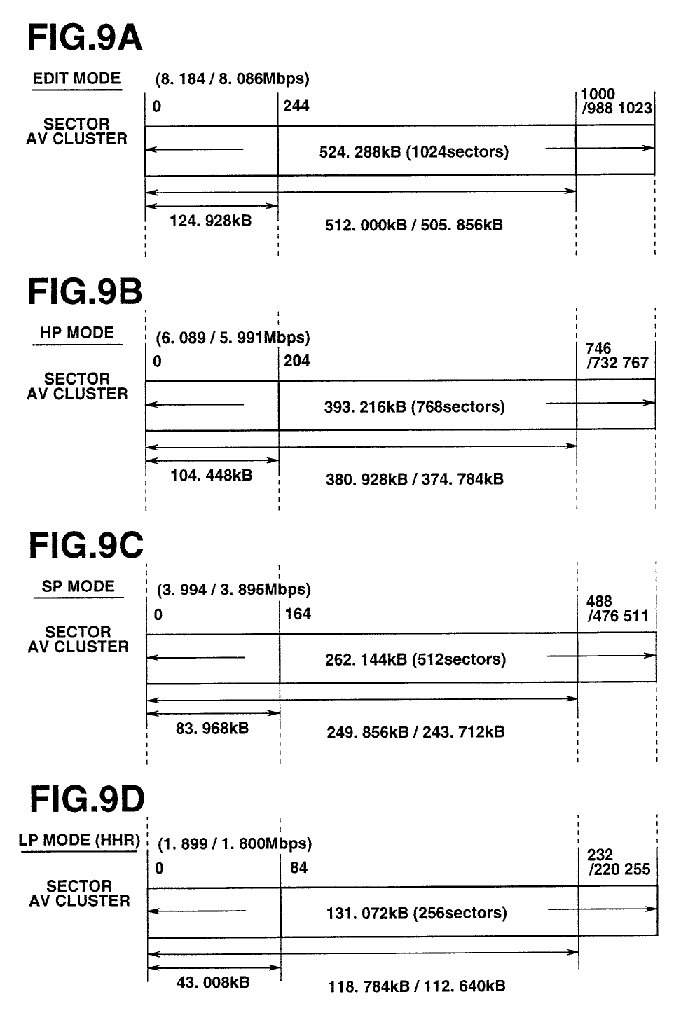

The AV data area has the size thereof changed at a compression rate corresponding to a selected mode for recording into the HDD 7. More particularly, as shown in FIG. 9(A), the AV data cluster has a whole size of 524.288 kilobytes for 1,024 sectors, of which a maximum of 124.928 kilobytes is for I pictures and 512/505.856 kilobytes is for GOP when the MPEG-2 compression rate is 8.184/8.086 Mbps (edit mode), for example.

As shown in FIG. 9(B), the AV data area has a whole size of 393.216 kilobytes for 768 sectors, of which a maximum of 104.448 kilobytes is for I picture and 380.928/374.784 kilobytes is for GOP when the MPEG-2 compression rate, is 6.089/5.991 Mbps (HP mode), for example.

When the MPEG-2 compression rate is 3.994/3.895 Mbps (SP mode), for example, the AV data area has a whole size of 262.144 kilobytes for 512 sectors), of which a maximum of 83.968 kilobytes is for I picture and 249.856/243.712 kilobytes is for GOP as shown in FIG. 9(C).

Also, when the MPEG-2 compression rate is 1.899/1.800 Mbps (LP mode (HHR)), for example, the AV data area has a whole size of 131.072 kilobytes for 256 sectors), of which a maximum of 43.008 kilobytes is for I picture and 118.784/112.640 kilobytes is for GOP as shown in FIG. 9(D).

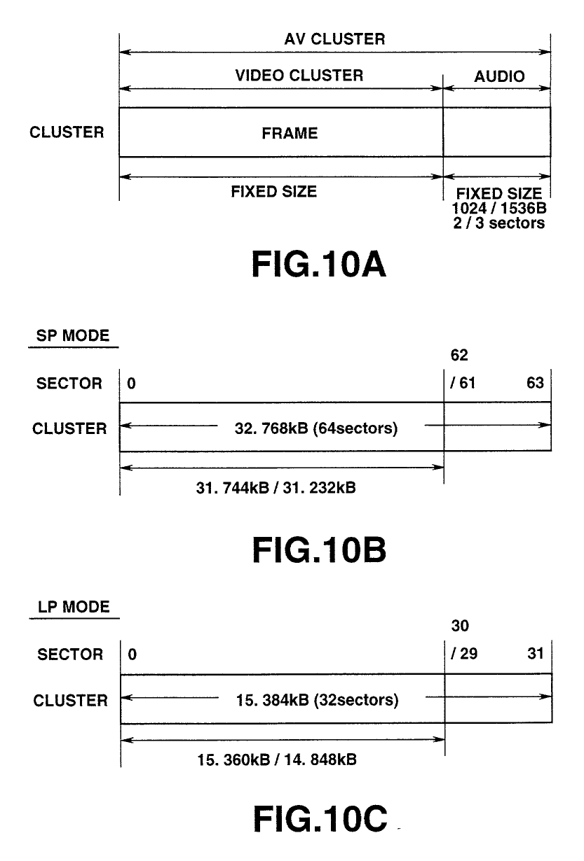

The recording mode has been described concerning an example of AV data compressed by the MPEG-2 method. However, the AV data may be compressed by the ATRAC method. Namely, an AV data compressed by the ATRAC method consists of a video cluster of a fixed size comprising a plurality of frames, and an audio cluster of a fixed size as shown in FIG. 10(A). The AV cluster shown in FIG. 10(A) is an example that a moving picture data is compressed by the Wavelet method and an audio data is compressed by the MPEG-Audio or ATRAC method. The audio cluster has a size of 1,024 bytes for 2 sectors when an audio data for recording into the audio cluster is compressed by the MPEG-Audio method, and a size of 1,536 bytes for 3 sectors when the ATRAC method is used to compress the audio data. Also, for a fixed size of the entire AV cluster, an video data for recording into the video cluster is compressed at a rate varied to fix the capacity of the whole AV cluster.

FIG. 10(B) shows an AV data for recording into the AV cluster, compressed in a recording mode of 7.611 Mbps or 7.488 Mbps. The AV data compressed in such a recording mode (SP mode) has a whole size of 32.768 kilobytes for 64 sectors, and the AV cluster has a size of 31.744 or 31.232 kilobytes.

FIG. 10(C) shows an AV data for recording into the AV cluster, compressed in a recording mode of 3.683 or 3.560 Mbps. The AV data compressed in such a recording mode (LP mode) has a whole size of 16.384 kilobytes for 32 sectors, and the AV cluster has a size of 15.360 or 14.848 kilobytes.

The memo data area records only a predetermined one, selected by a control input signal entered by the user, for example, of AV data recorded in the above-mentioned AV data area. The recording format and others for the memo data area are similar to those for the AV data area. Namely, the data are recorded timewise continuously, namely, as in the ring-storage structure. Further, the memo data area has a smaller size than the AV data area.

The audio data area stores audio data and still picture data, for example. Different from AV data and memo data for recording into the AV data area and memo data area, audio data is not recorded timewise continuously but recorded and/or reproduced by a random access to the audio data area.

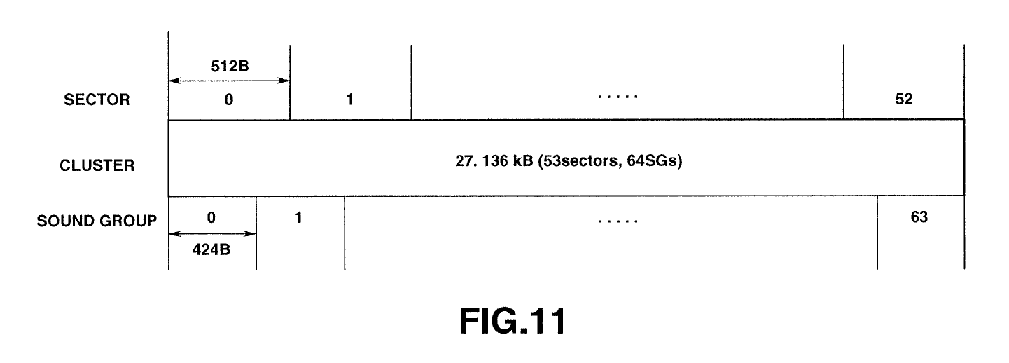

FIG. 11 shows an example of the compression by the ATRAC method of an audio data for storage into the audio data area. The audio data for recording into the audio data area is compressed/decompressed in units called “sound group” and recorded as a data of 424 bytes. Since an audio data is recorded in each sector of 512 bytes (one sector is the smallest recording unit) in the HDD 7, the least common multiple between the 424 and 512 bytes is taken as the smallest recording unit in this embodiment. In the embodiment, the least common multiple between 424 and 512 bytes is 27136, so the audio data area is of 27.136 kilobytes for 53 sectors and 64 sound groups.

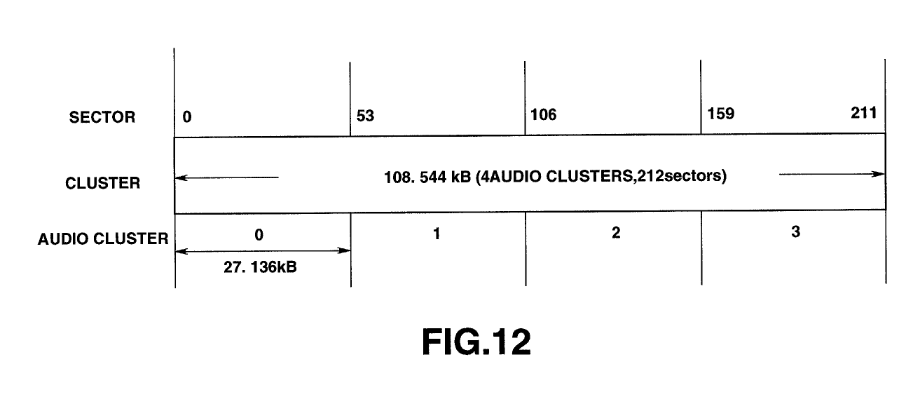

A static picture data for storage into the audio data area is compressed by the JPEG (Joint Photographic coding Experts Group) method. As shown in FIG. 12, it is composed of 212 sectors, and four audio clusters are stored as the still picture data into the audio data area. The recoding unit for the still picture data is 108.544 kilobytes.

The second system area is a reserved area having a CG data area of 20,480 sectors and a system reserved area of 65,536 sectors.

As shown in FIG. 4, the backup area has a similar configuration to those of the lead-in area and first system area. The backup area records the contents of the lead-in and first system areas as they are, and so it is used against any trouble.

Different from the lead-in and system areas, the backup area has a root area which is to be the last LBA. Namely, the backup area is of a fixed size in a range of LBA 0 to LBA N, so that although the lead-in area, for example, cannot be reproduced due to a trouble, access can be made to the backup area and the segmentation position information can be read from the recording medium.

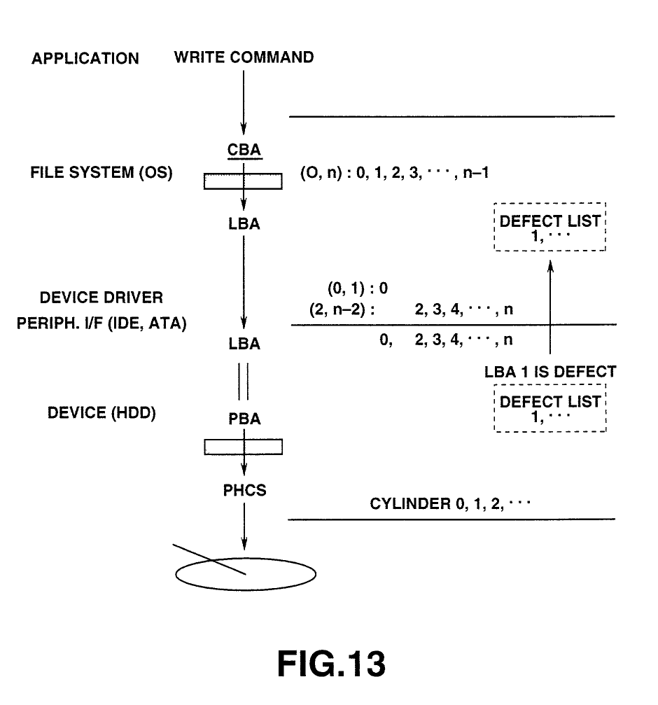

In the information recording and/or reproducing apparatus 1 according to the present invention, an recording or write instruction, for example, is entered by the user into the CPU 9 for access to a predetermined sector in the recording medium in the HDD 7. The method of address conversion for the purpose of this access to a predetermined sector will be described with reference to FIG. 13.

Here it is assumed that the user of the information recording and/or reproducing apparatus 1 according to the present invention operates an external control input device such as a keyboard to supply the CPU 9 with a control input signal indicative of a write command to write an AV data to the recording medium in the HDD 7.

The CPU 9 will interpret the write instruction according to an application program stored in the CPU 9 and which corresponds to the write command, and converts it to continuous block addresses (henceforth, CBA) which are addresses having continuous values before conversion to LBAs (logical block address).

The CPU 9 will interpret, by the file system (an OS component) stored therein, the write command as an instruction for writing to n sectors beginning with LBA 0, for example, like(0, n): 0, 1, 2, 3, . . . , n−1 as shown in FIG. 13. Then, the file system will convert CBAs having continuous values to LBAs. At this time, referring to each defect list stored in the RAM 10, the CPU 9 will execute the slip alternation process to allow the write/read head or magnetic head to slip over a defective sector and go to a normal sector next to the defective one. Thus the CBA is converted to a writable LBA. More particularly, referring to the defect list and finding in the defect list an LBA or LBAs incurring a secondary defect, the CPU 9 converts the CBAs to LBAs to write to only other LBAs than those incurring a secondary defect. Namely, the LBAs selected by the CPU 9 will have discrete values. For example, when the defect list stores defective LBAs like 1, . . . , the CPU 9 will convert CBAs to LBAs so that write is made only to LBAs from LBA 0 to sector 0 in a range of LBA 0 to sector 1 as indicated with (0, 1): 0 in FIG. 13 and write is made sequentially to a range of LBA 2 to sector n−2 as indicated with (2, n−2): 2, 3, 4, . . . , n. The defect list in the RAM 10 is generated, at the start-up of the information recording and/or reproducing apparatus 1, based on an information that a secondary defect has taken place at LBA 1. The information is available from the secondary defect list stored in the recording medium in the HDD 9.

The CPU 9 will supply the LBAs converted referring to the defect list to the ATA adapter 8 via the host bus 6. The ATA adapter 8 will interpret the LBAs supplied from the CPU 9 as an instruction to write to LBAs 0, 2, 3, 4, . . . , n and convert the LBAs to physical block addresss (henceforth, PBA) which will be supplied to the HDD 7.

The HDD 7 will drive the magnetic head, for example, correspondingly to a signal from the ATA adapter 8 for access to each sector via the cylinder.

Since in the information recording and/or reproducing apparatus 1 according to the present invention, CBAs having continuous values are compared with the defect list, and converted to continuous LBAs slipping over LBAs incurring a secondary defect, so it is possible to access to each sector in the recording medium timewise continuously. Therefore, in the information recording and/or reproducing apparatus 1, even if the magnetic disc, for example, incurs a secondary defect, each sector can be accessed without any increased time for seeking by the magnetic head.

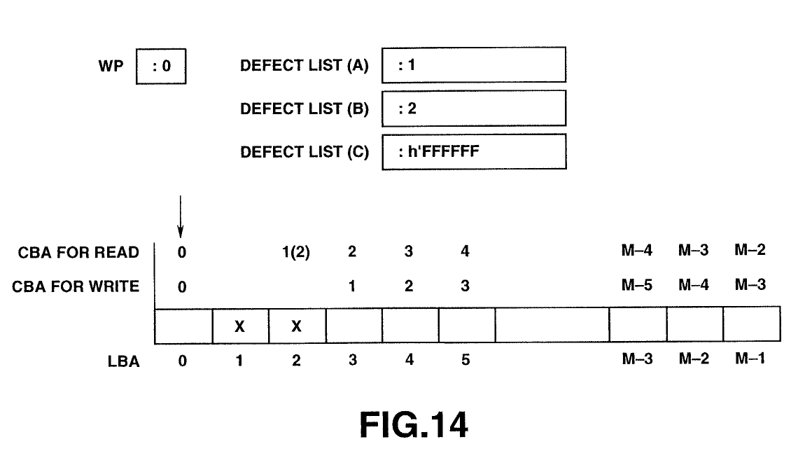

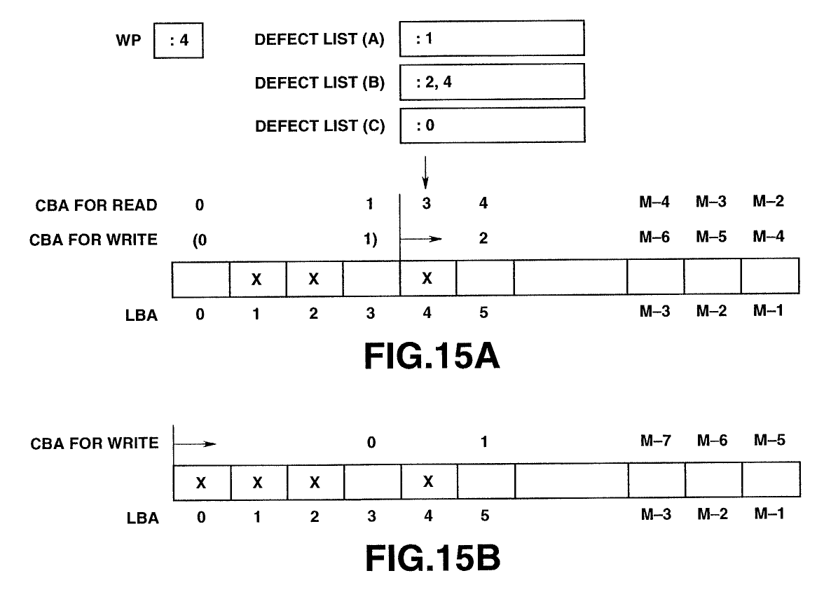

Next, an example of the slip alternation process executed by the information recording and/or reproducing apparatus 1 referring to the first defect list (A), second defect list (B) and third defect list (C) will be discussed with reference to FIGS. 14 and 15.

FIG. 14 shows an example that “1” is stated in the first defect list A) when the write point (henceforth, WP) is at LBA 0. In this case, when read is made from LBA 0 on the recording medium, first the CPU 9 will generate continuous CBAs such as 0, 1, 2, 3, 4, 5, . . . , m−3, m−2, m−1 according to a read command from the user.

In the information recording and/or reproducing apparatus 1, when WP=0, read from the recording medium will be done referring only to the first defect list while disregarding the second and third defect lists. The CPU 9 will apply the slip alternation process to convert continuous CBAs to LBAs 0, 2, 3, 4, 5, . . . , m−4, m−3, m−2. That is to say, the CPU 9 will apply the CBAs 0, 2, 3, 4, 5, . . . , m−4, m−3, m−2 to LBAs 0, 1, 2, 3, 4,. . . , m−4, m−3, m−2 on the recording medium. As a result, other than LBA 1 will be read. At this time, the CPU 9 refers to the defect list to decrease the entire capacity (total value of CBAs) by the defect sectors.

The CPU 9 will supply the LBAs generated through the slip alternation to the HDD 7 via the ATA adapter 8 and allow the HDD 7 to read. Then, the HDD 7 will read according to LBAs supplied from the CPU 9.

Assume here that a sector accessed as LBA 2 by the CPU 9 is not readable. The ATA adapter 8 will be supplied with a signal indicating that the magnetic head, for example, cannot read the recording medium. The ATA adapter 8 will generate an error status supply it to the CPU 9. Based on the error status supplied from the ATA adapter 8, the CPU 9 will interpret that a sector represented by the LBA 2 is not readable due to a secondary defect, and newly register the LBA 2 into the second defect list.

Write to WP (write point) =0 and subsequent addresses on the recording medium will be done referring to the first and second defect lists. At this time, write to sectors represented by LBA 1 and LBA 2 will be done referring to the first and second defect lists. More particularly, when the CPU 9 interprets a write command from the user as an instruction for writing AV data to CBAs 0, 1, 2, 3, 4, 5, . . . , m−3, m−2 and m−1, it will refer to the first and second defect lists to generate corresponding LBAs. Namely, since LBA 1 and LBA 2 are found not writable as a result of the reference to the first and second defect lists, the slip alternation is effected to record the AV data. As a result, CBA 1 is slipped to LBA 3 and CBA 2 is slipped to LBA 4.

Next, an example of AV data read to WP=4 and subsequent addresses in the information recording and/or reproducing apparatus 1 will be described herebelow. An example of write to WP=4 and subsequent addresses after write up to CBA 1 in the above write to WP=0 and subsequent addresses will also be described. At this time, only LBA 1 is defective in the first defect list as shown in FIG. 15. For read from WP=4, reference is made only to the first defect list, not to the second and third defect lists as shown in FIG. 15(A). On the other hand, for read from LBA 0 to 3, reference is made to the first and second defect lists but not to the third defect list, since the above write has been made.

If a sector represented by LBA4 is found not readable when read from WP=4 and subsequent, the HDD 7 will generate and deliver an error status to the CPU 9 via the ATA adapter 8. According to the error status supplied via the ATA adapter 8, the CPU 9 will add to the second defect list in the RAM 10 an information indicating that LBA 2 is defective. As a result, the second defect list will register “2, 4”.

If sectors represented by LBA 0 to 3 are read and an sector represented by LBA 0 is found not readable, the HDD 7 will generate and deliver an error status to the CPU 9 via the ATA adapter 8. The CPU 9 will newly register “0” into the third defect list in the RAM 10 according to the error status supplied from the ATA adapter 8.

On the other hand, for write of AV data to WP=4 and subsequent addresses after read from WP−4, reference is made to the second defect list. Since a sector represented by LBA 4 is found to incur a secondary defect as a result of the above read, the AV data for write to a sector represented by LBA 4 is slipped to a sector represented by LBA 5. More particularly, when the CPU 9 is supplied with a command for write to CBA 4, 5, . . . , it will refer to the first and second defect lists. When the CPU 9 interprets that the sector represented by LBA 4 is defective, it will execute the slip alternation to slip CBA 4 to LBA 5, and also the subsequent. As a result, write will be done to LBA 5 and subsequent LBAs. Thus, write will be made to addresses from WP=4 up to CBA m−4. If the CPU 9 interprets, as a result of the write, that a sector represented by LBA 4 is defective, the capacity of the AV data area is decreased to m-3 sectors.

For writing AV data to LBA 0 and subsequent LBAs again after the write to WP=4, the CPU 9 will record the first and second defect lists into the first defect list and the third defect list into the second defect list to update the second defect list in the RAM 10, as shown in FIG. 15(B). Then, the CPU 9 will record AV data using the updated first and second defect lists. Namely, since sectors represented by LBA 0, 1 and 2 are defective as known from the first and second defect lists, the CPU 9 will record CBA 0 into LBA 3 and CBA 1 into LBA 5.

Since in the information recording and/or reproducing apparatus 1, data are written timewise continuously in the AV data area, the slip alternation can be effected in the AV data area for overwriting. Therefore, even if a sector represented by a certain LBA incurs a secondary defect, slip is made over the defective sector to a sector represented by a next LBA timewise contiguous to the LBA representing the defective sector and an AV data is written to the normal sector and the continuity of the AV data can thus be maintained. Further in the information recording and/or reproducing apparatus 1, since it is not necessary, when an intended sector incurs a secondary defect, to access to an alternative sector as in the file system for a personal computer, the seek time of the magnetic head, for example, and latency of the recording medium can be reduced considerably, so the continuity of the AV data can be maintained and a moving picture and sound can be written timewise continuously to, and/or read from, the recording medium in the information recording and/or reproducing apparatus 1.

In the information recording and/or reproducing apparatus 1, the above-mentioned slip alternation will reduce the capacity of the AV data area, but since the AV data area is of the so-called ring-storage structure, the user will not be aware of the reduction of AV data area capacity due to the slip alternation.

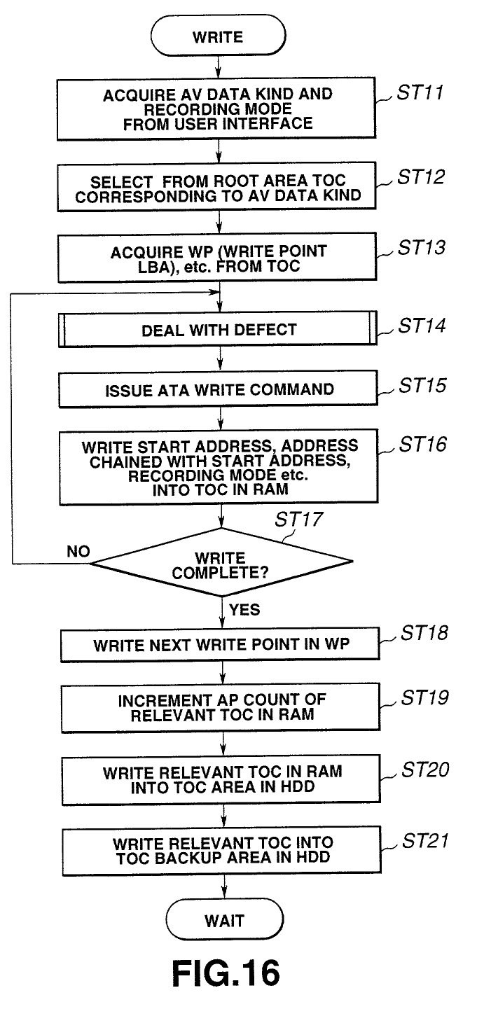

Next, an example of the write of AV data into the AV data area on the recording medium by the information recording and/or reproducing apparatus 1 adopting the slip alternation process, will be discussed below with reference to a flow chart shown in FIG. 16.

As in the flow chart, first the CPU 9 is supplied with a control input signal from the user, for example, at step ST11. The CPU 9 will interpret the kind of an AV data to be recorded and the mode of recording according to the control input signal, and go to step ST12. The kind of AV data includes a content of a moving picture, for example. The recording mode includes an information such as compression system and compression rate for the compression system, for example.

At step ST12, the CPU 9 will reproduce a TOC area from a root area in which the segmentation position information on the AV data area, according to the kind of AV data acquired at step ST11, and select a management information for a to-be-recorded content according to the control input signal. Then, the CPU 9 will go to step ST13.

At step ST13, the CPU 9 will acquire a write start LBA (WP) from the management information in the TOC area selected at step ST12, and then go to step ST14.

At step ST14, the CPU 9 will execute the slip alternation process having been described with reference to FIGS. 14 and 15, according to the control input signal entered by the user, to deal with a secondary defect, and then go to step ST15. In this defect dealing procedure, LBAs to which the AV data is to be written are generated based on the supplied control input signal. The LBAs generated in the defect dealing procedure are discrete for continuous CBAs because defective ones are excluded in the defect dealing procedure. The operation of the CPU 9 to deal with a secondary defect will further be discussed later.

At step ST15, the CPU 9 will supply the LBAs generated in the defect dealing procedure as an ATA write command to the ATA adapter 8, and then go to step ST16.

At step ST16, the CPU 9 will update TOC, write start LBA, LBA chained with the write start LBA, recording mode, etc. stored in the RAM 10. More particularly, the CPU 9 will recognize the AV data to be written into the recording medium in the HDD 7 according to the control input signal entered by the user, and generate information indicative of content of the AV data, write start LBA and compression rate which will be supplied to the RAM 10. Then it goes to step ST17.

At step ST17, the CPU 9 will judge whether all AV data supplied from the MPEG-2 encoder 2 have been recorded into the recording medium in the HDD 7. When it decides that the AV data have not been recorded, the above steps ST14 to ST16 will be repeated to record the remaining AV data. When the CPU 9 decides that all the AV data have been recorded, it will go to step ST18.

At step ST18, the CPU 9 will record a position where the recording is complete at step ST17, as a next write start position (WP), and then go to step ST 19.

At step ST19, the CPU 9 will increment the APCount stored in the RAM 10 since the content of TOC area has been updated at step ST16, and then go to step ST20.

At step ST20, the CPU 9 will record a TOC area information stored in the RAM 10 into an TOC area in the system area of the HDD 7, and then go to step ST21.

At step ST21, the CPU 9 will record the system-area TOC area information having been recorded at step ST20 as it is into an TOC area in the backup area, and then end the recording operation. Then the CPU 9 will enter the standby status.

In the information recording and/or reproducing apparatus 1, an AV data is written to the AV data area after LBAs to which data is to be written are determined by the CPU 9 by referring to the first and second defect lists and then subjected to the slop alternation process. Therefore, even if a secondary defect takes place in the AV data area, the write can be done with a reduced seek time and latency of the magnetic head, for example.

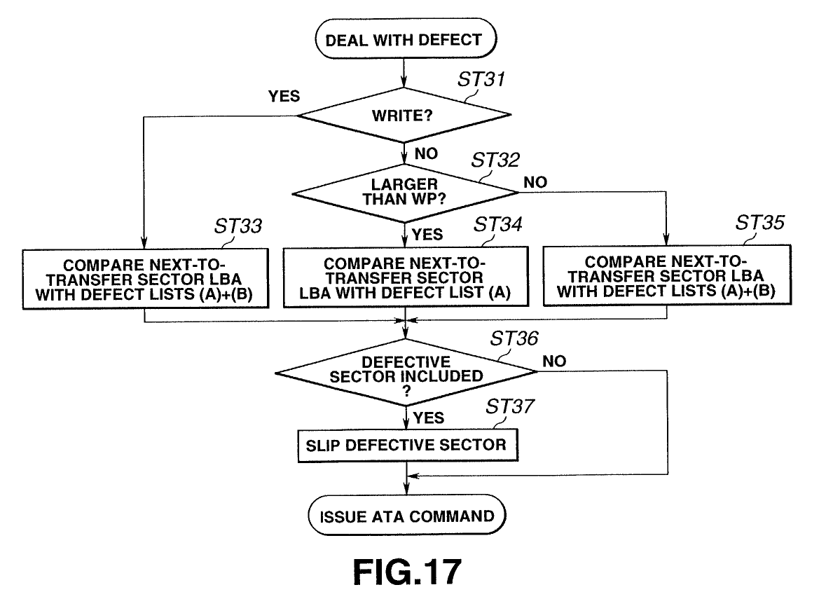

Next the defect dealing procedure done at step ST14 will be described herebelow with reference to FIG. 17. As shown in FIG. 17, the CPU 9 will judge based on a control input signal entered by the user, at step ST31, whether AV data is to be written or read based on the control input signal entered by the user. When the CPU 9 decides that the AV data is to be read, it swill go to step ST32. If the CPU 9 decides that the AV data is to be written, it will go to step ST33.

At step ST32, the CPU 9 will judge whether the AV data is to be read from an larger or smaller LBA than a WP having been acquired at step ST13. When the CPU 9 decides that the read is to be done from the larger LBA, it will go to step ST34. If the CPU 9 decides that the read is to be done from a smaller LBA, it will go to step ST35.

At step ST34, the CPU 9 will make a comparison between the LBA from which the AV data is to be read with the first defect li, and then go to step ST36. On the other hand, at step ST35, the CPU 9 will compare the LBA from which the AV data is to be read with the first and second defect lists, and then go to step ST38.

When the CPU 9 decides at step ST31 that the AV data is to be written, it will compare, at step ST33, the LBA to which the AV data is to be written with the first and second defect lists, and then go to step ST36.

At step ST36, the CPU 9 will judge, based on the results of comparison at steps ST33, ST34 and ST35, whether any defect LBA is included in the LBAs to or from which the AV data is to be written or read, and then go to step ST37.

At step ST37, the CPU 9 will execute the slip alternation to slip over the defective LBA for write or read of the AV data to normal LBAs. As a result, the LBAs to or from which write or read is to be done include no defect LBAs.

The CPU 9 will generate, at step ST37, a control signal to designate a write or read of AV data to or from other LBAs than defective ones, and then go to step ST45.

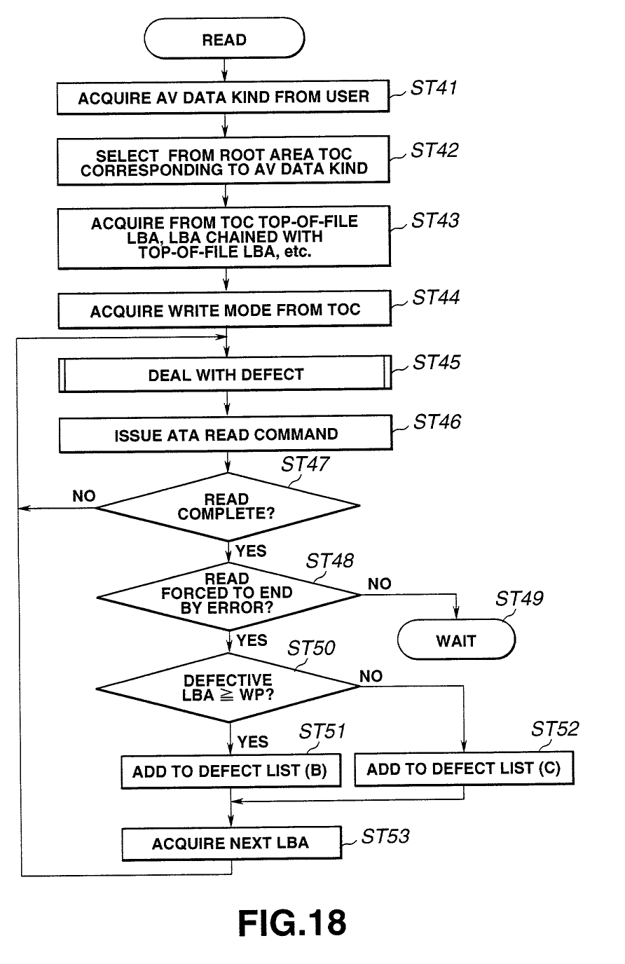

An example of the read of AV data from the AV data area on the recording medium in the information recording and/or reproducing apparatus 1 will be described herebelow with reference to a flow chart shown in FIG. 18.

First at step ST41, the CPU 9 will be supplied with a control input signal entered by the user, for example. The CPU 9 will interpret, based on the supplied control input signal, the kind of an AV data to read, and go to step ST42. The kind of AV data includes content of a moving picture, etc.

At step ST42, the CPU 9 will reproduce a TOC area from a root area in which the segmentation position information on the AV data area is stored, based on the kind of AV data acquired at step ST41, and select a management information of a content to be read, based on the control input signal. Then it will go to step ST43.

At step ST43, the CPU 9 will recognize a write start LBA for an information to read and an LBA chained with the write start LBA, from the TOC area management information having a content read at step ST42, and then go to step ST44.

At step ST44, the CPU 9 will acquire a recording mode from the TOC area management information having been read at step ST42, and go to step ST45. The recording mode includes a compression system and compression rate for the compression system, for example.

At step ST45, the CPU 9 will execute, based on the control input signal entered by the user, the slip alternation process as having been discussed with reference to FIGS. 14 and 15 to deal with any secondary defect, and then go to step ST46. In the defect dealing procedure, the CPU 9 will generate LBAs from which data is to be read based on the control input signal. The LBAs thus generated are discrete, including no defective LBAs, for continuous CBAs. The defect dealing by the CPU 9 will be discussed in further detail later.

At step ST46, the CPU 9 will supply the ATA adapter 8 with a ATA read command indicative of LBAs having been generated at step ST45 and from which data is to be read, and then go to step ST47.

In the HDD 7, the recording medium will be read based on the LBAs generated in the defect dealing procedure.

At step ST47, the CPU 9 will judge whether the HDD 7 has completed the read from sectors represented by the generated LBAs. At this time, the CPU 9 will judge whether the read has been complete in the HDD 7, based on whether a signal indicative of the completion of the read has been supplied from the ATA adapter 8. When the CPU 9 decides that the read has been ended, it will go to step ST48. If the CPU 9 decides that the read has not been ended, it will go to step ST45 where the operations at steps ST45 and ST47 are repeated to read sectors represented by all LBAs designated by the user.

At step ST48, the CPU 9 will judge whether the read has been ended at step ST47 due to an error “not readable because of a secondary defect in the recording medium”, for example. When the CPU 9 decides that the read has been ended due to such an error, it will go to step ST50. On the other hand, if the CPU 9 decides that the read has been ended not due to any error but because all LBAs have been read, it will go to step ST49.

At step ST50, the CPU 9 will judge whether the defective LBA found not readable at step ST48 is larger or smaller than the write start LBA recorded at step ST18. If the CPU 9 decides that the defective LBA is larger than the write start one, it will go to step ST51. If the CPU 9 decides that the defective LBA is smaller than the defective LBA, the CPU 9 will go to step ST52.

At step ST51, the CPU 9 will additionally record into the second defect list in the RAM 10 the defective LBAs which cannot have been read at step ST48 because they are decided, at step ST50, to be larger than the write start LBA, and then go to step ST53.

On the other hand, at step ST52, the CPU 9 will additionally record into the third defect list in the RAM 10 the defective LBAs which cannot have been read at step ST48 because they are decided, at step ST50, to be smaller than the write start LBA, and then go to step ST53.

At step ST53, the CPU 9 will return to step ST45 to read a sector represented by an LBA next to the defective LBA detected at step ST48 and additionally registered into the RAM 10 at steps ST51 and ST52. The CPU 9 will repeat steps ST45 to ST52 to consequently read a content corresponding to the control input signal entered to the CPU 9 by the user.

To read data In the information recording and/or reproducing apparatus 1 according to the present invention, the first defect list is used when an LBA from which read is to be done is larger than a WP (write point) LBA. When the LBA is smaller than WP, the first and second defect lists are used. Thus, data read can be done with a higher reliability.

The embodiment of the information recording and/or reproducing apparatus according to the present invention has been described in the foregoing concerning the example of slip alternation the CPU 9 executes against a secondary defect based on an error status supplied from the ATA adapter 8. However, the dealing with the secondary defect may be done after completion of data write or read. Namely, when data read is done in the information recording and/or reproducing apparatus 1, an error status generated for a defective sector is disregarded to end the read. After termination of the read, the HDD 7 supplies the CPU 9 with a signal indicative of the defective LBA among the sectors having been read under a predetermined command, and the CPU 9 additionally registers the defective LBA into the RAM 10. By registering the defective LBA into the RAM 10 after completion of the data read, it is possible to read data and deal with the defective LBA efficiently.

The embodiment of the present invention has been described also concerning the example that the CPU 9 executes the slip alternation for dealing with a secondary defect in the AV data area. However, the slip alternation process may be done at the HDD 7. In this case, a CPU inside the HDD 7 will execute the slip alternation for the defective LBA in a range defined by an information supplied from the CPU 9 and indicative of a top LBA and end LBA of the AV data area. In this case, addresses supplied as continuous LBAs (CBAs in this embodiment) from the host system are converted to discrete LBAs in the HDD 7.

As having been described in the foregoing, in the information recording and/or reproducing apparatus and method according to the present invention, information signal is record and/or reproduced to and/or from a logical block timewise contiguous to a logical block found defective based on an information of a secondary defect detected by the defect dealing means. Thus, even if a logical block to and/or from which data is written and/or read incurs a secondary defective, it is possible to record and/or reproduce a data such as a moving picture or sound timewise continuously recorded while maintaining the timewise continuity of them.

Also, in the information recording and/or reproducing apparatus and method according to another aspect of the present invention, information signal is recorded and/or reproduced to and/or from a user data area on a disc-shaped recording medium irrespectively of any secondary defect in the user data area, while detecting the secondary defect taking place in the disc-shaped recording medium, storing, as a logical block number, a detected secondary defect having taken place in any of the logical blocks in the user data area and supplying as an output the secondary defects after the recording and/or reproduction of the information signal. Therefore, even if a secondary defect takes place in a disc-shaped recording medium, timewise continuous data such as a moving picture and sound can be recorded and/or reproduced while maintaining the continuity of the data. Also, in the information recording and/or reproducing apparatus and method according to a still another aspect of the present invention, information signal is recorded and/or reproduced referring to a logical block number of a logical block incurring a secondary defect, found during the preceding recording and/or reproduction. Therefore, the information signal can be recorded and/or reproduced timewise continuously.

What is claimed is:

1. An information recording and/or reproducing apparatus, comprising:
a disc-shaped recording medium having a management information area and a user data area including a plurality of logical blocks;
means for writing and/or reading information signal to and/or from at least a part of the user data area on the disc-shaped recording medium; and
means for dealing with a defect by detecting a logical block incurring a secondary defect having taken place in the user data area on the disc-shaped recording medium and generating a secondary defect information;
the writing and/or reading means writing and/or reading information signal to and/or from a next logical block timewise contiguous to a logical block decided to be defective based on the secondary defect information generated by the defect dealing means.

2. The apparatus as set forth in claim 1, further comprising:
means for controlling the writing and/or reading means to write information signal by decreasing its size for recording into the disc-shaped recording medium correspondingly to the secondary defect information supplied from the defect dealing means.

3. The apparatus as set forth in claim 1, further comprising:
means for storing, as a secondary defect list, the secondary defect information supplied from the defect dealing means;
the defect dealing means using the secondary defect information to store as into the defect storing means the secondary defect list a logical block number for a logical block incurring the second defect.

4. The apparatus as set forth in claim 3, wherein the defect dealing means is adapted to generate two or more kinds of secondary defect lists and store them into the defect storing means.

5. The apparatus as set forth in claim 4, wherein the controlling means is adapted to keep a write point at which write has been started by the writing and/or reading means and allow the writing and/or reading means to read, using the secondary defect list different one from another depending upon a geometric relation between the write point and a read point.

6. The apparatus as set forth in claim 1, wherein the writing and/or reading means is adapted to write information signal into the disc-shaped recording medium by executing a ring-storage method in which the information signal is written continuously into logical blocks ranging from a write start logical block to a write end logical block and the information signal is overwritten from the write start logical block again.

7. The apparatus as set forth in claim 4, wherein the defect dealing means is adapted to detect, as a secondary defect information, a first defect list showing all logical blocks having secondary defects detected before a write preceding an overwrite, a second defect list showing logical blocks having secondary defects detected when read is made from an area written before the overwrite, and a third defect list showing logical blocks having secondary defects detected when read is made from areas written using the first and second defect lists.

8. The apparatus as set forth in claim 7, wherein the defect dealing means is adapted to take the first and second defect lists as a first defect list and the third defect list as a second defect list when the writing and/or reading means writes information signal into a logical block having a largest logical block number in the user data area.

9. The apparatus as set forth in claim 8, wherein the controlling means allows the writing and/or reading means to write and read, using the first and second defect lists, to and/or from a logical block timewise preceding a position where the write is made, while allowing the writing and/or reading means to write and/or read, using the first defect list, to and/or from a logical block timewise after the write position.

10. An information recording and/or reproducing method, comprising the steps of:
detecting a logical block incurring a secondary defect having taken place in a user data area on a disc-shaped recording medium having a management information area and a user data area including a plurality of logical blocks; and
writing and/or reading information signal to and/or from a next logical block timewise contiguous to the defective logical block.

11. The method as set forth in claim 10, further comprising the step of:
writing information signal by decreasing its size for recording into the disc-shaped recording medium correspondingly to a number of logical blocks incurring defects having taking place in the user data area.

12. The method as set forth in claim 10, further comprising the steps of:
storing, as a secondary defect list, a logical block number for a logical block incurring the detected defect;
writing and/or reading by using the secondary defect.

13. The method as set forth in claim 12, further comprising the steps of:
generating two or more kinds of secondary defect lists; and
writing and/or reading by using the two or more kinds of secondary defect lists.

14. The method as set forth in claim 13, further comprising the steps of:
keeping a write point at which information signal is to be written next; and
writing by using the secondary defect list different one from another depending upon a geometric relation between the write point and a read point.

15. The method as set forth in claim 10, further comprising the step of:
writing information signal into the disc-shaped recording medium by executing a ring-storage method in which the information signal is written continuously into logical blocks ranging from a write start logical block to a write end logical block and the information signal is overwritten from the write start logical block again.

16. The method as set forth in claim 13, further comprising the steps of:
detecting, as a secondary defect information, a first defect list showing all logical blocks having secondary defects detected before a write preceding an overwrite, a second defect list showing logical blocks having secondary defects detected when read is made from an area written before the overwrite and a third defect list showing logical blocks having secondary defects detected when read is made from areas written using the first and second defect lists; and
writing and/or reading by using the first, second and third defect lists.

17. The method as set forth in claim 16, wherein the first and second defect lists are taken as a first defect list and the third defect list is taken as a second defect list when information signal is written into a logical block having a largest logical block number in the user data area.

18. The method as set forth in claim 17, further comprising the steps of:
reading to a logical block timewise preceding a position where the write is made using the first and second defect lists; and
writing and/or reading to and/or from a logical block timewise after the write position, by using the first defect list.

19. An information recording and/or reproducing apparatus, comprising:
means for writing and/or reading information signal to and/of from a user data area, including a plurality of logical blocks, on a disc-shaped recording medium having also a management information area, irrespectively of the existence of a secondary defect in the user data area, while detecting a secondary defect having taken place in the disc-shaped recording medium;
means for storing, as a logical block number, a secondary block detected by the writing and/or reading means in any of the logical blocks of the user data area; and
means for supplying as an output the secondary defect stored in the defect storing means, after write and/or read of the information signal to and/or from the writing and/or reading means.

20. The apparatus as set forth in claim 19, further comprising means for controlling the writing and/or reading means;
the writing and/or reading means being supplied with a write start logical block and write end logical block from the controlling means to write information signal into the disc-shaped recording medium by executing a ring-storage method in which the information signal is written continuously into logical blocks from a write start logical block to a write end logical block and the information signal is overwritten from the write start logical block again.

21. The apparatus as set forth in claim 20, wherein the writing and/or reading means is adapted to write and/or read information signal to and/of from a next logical block timewise contiguous to a logical block having a secondary defect detected between the write start logical block and write end logical block supplied from the controlling means.

22. An information recording and/or reproducing method, comprising the steps of:
writing and/or reading information signal to and/or from a user data area, including a plurality of logical blocks, on a disc-shaped recording medium having also a management information area, irrespectively of the existence of a secondary defect in the user data area, while detecting a secondary defect having taken place in the disc-shaped recording medium;
storing as a logical block number a secondary defect having taken place in any of the logical blocks in the user data area; and
supplying as an output the stored secondary logical block number after write and/or read of the information signal.

23. The method as set forth in claim 22, further comprising the step of:
writing information signal into the disc-shaped recording medium by executing a ring-storage method in which the information signal is written continuously into logical blocks ranging from a write start logical block to a write end logical block and the information signal is overwritten from the write start logical block again.

24. The method as set forth in claim 22, further comprising the step of:
writing and/or reading information signal to and/or from a logical block timewise contiguous to a logical block having a secondary defect detected between the write start logical block and write end logical block.
